(19) United States
(12) Patent Application Publication
(10) Pub. No.: US 2011/0301871 A1
(43) Pub. Date: Dec. 8, 2011

(54) METHOD FOR DETERMINING A STATE OF AT LEAST ONE COMPONENT OF A CONTROL UNIT

(76) Inventors: Benoit Budiscak, Sachsenheim (DE); Thomas Figuth, Stuttgart (DE); Thomas Dingler, Stuttgart (DE); Markus Meisinger, Stuttgart (DE); Frank Prohaska, Stuttgart (DE)

(21) Appl. No.: 13/139,270

(22) PCT Filed: Nov. 24, 2009
(86) PCT No.: PCT/EP2009/065752

§ 371 Date: Aug. 25, 2011

(30) Foreign Application Priority Data
Dec. 11, 2008 (DE) 102008054511.2

(51) Int. Cl. G06F 19/00; G01K 13/00

(52) U.S. Cl. 702/34; 702/130

(57) ABSTRACT

A method for determining a state of at least one component of a control unit, in which a temperature of the at least one component is determined, a type of temperature change being detected and recorded for a number of temperatures which are determined over a time period, recorded temperature changes being used to determine the state. Also described is a system for determining a state of at least one component of the control unit, a control unit, a computer program and a computer program product.

### FIELD OF THE INVENTION

The present invention relates to a method for determining a state of a component of a control unit, a system for determining a state of a component of a control unit, a control unit, a computer program and a computer program product.

### BACKGROUND INFORMATION

An electronic device, for example a control unit for a motor vehicle, is subject to wear during operation, which may result in damage to the device over time so that the latter is no longer functional. In order to detect such damage early, the device must normally be disassembled and opened so that components inside the device may be examined.

### SUMMARY OF THE INVENTION

The exemplary embodiments and/or exemplary methods of the present invention relates to a method for determining a state of at least one component of a control unit in which a temperature of this at least one component is determined or ascertained, a type of temperature change being detected and recorded for a number of temperatures which are determined or ascertained over a time period and the recorded temperature changes being used to determine the state.

By determining the state it is possible to detect aging of the component, among other things. This relates, for example, to the aging of connecting points or joints of the component, if different materials are usually connected or joined together there. Such connecting points or joints may be designed as soldered points or soldered connections.

Normally not all of the temperatures that are determined are stored; a summary selection is made of typically time-dependent temperature changes. By observing the temperature changes over an extended time period, it is possible to determine the thermal loads to which the at least one component, and thus also at least one soldering point of the component, is subjected.

Furthermore, to detect a temperature change from the determined temperature, at least one temperature delta that corresponds to a temperature difference between a local maximum and a local minimum of the temperature is determined and recorded. The connecting points or joints are especially affected by the temperature changes that arise during operation of the control unit, so that their aging may be accelerated by the temperature change.

However, a counter may be set up for the at least one temperature delta, with which statistics for the latter are registered. In this variant there is a check of how long the temperature of the component remains within the at least one temperature delta.

The counter for the at least one temperature delta is incremented by one when the temperature difference which corresponds to the at least one temperature delta is exceeded. That makes it possible to determine how often the at least one component has passed through the temperature delta.

The design may take account of the direction of a temperature change, a rising temperature delta being established in the event that the temperature rises and a falling temperature delta in the event that the temperature drops. In consequence, the direction is established by whether the temperature rises or drops within the temperature delta. A temperature change within a temperature delta contrary to the direction of the temperature delta, that is smaller than the temperature delta, may be ignored.

It is provided, among other things, that a temperature of the at least one component is stored as the control unit is switched off. When the control unit is subsequently switched on, the temperature of the at least one component is determined, the temperature determined while switching off being compared with the temperature determined while switching on.

Typically, the method may be carried out for at least one component of the control unit designed as a circuit board and/or for one connecting point of the circuit board or control unit designed as a soldering point. Furthermore, the method may be carried out for any other component within the control unit, and thus for the control unit, so that the state or the aging of the control unit may be monitored.

The system that is also provided for determining a state, including aging, of at least one component of a control unit, has a thermometer that is designed to determine or to ascertain, for at least one point of the at least one component of the control unit, a temperature of that component. The system also has at least one data processing unit which is designed to record a type of temperature change for a number of temperatures which are determined or ascertained over a time period, and to use recorded temperature changes to determine the state.

The control unit according to the present invention has at least one described system according to the present invention for determining a state of at least one component of the control unit.

The method is used in part to provide a model for the aging of the mechanics, typically a soldering point, of a control unit, as a function of the temperature change within the control unit.

This is designed to be done by recording the temperature changes while taking into account temperature differences or temperature variations, normally so-called temperature deltas, with which the rise and drop of the temperature during operation of the control unit may be documented. The result is that possible damage to a component, for example a circuit board, as a temperature-sensitive component of the control unit, may be detected significantly better, and thus a significantly more precise statement may be made about the service life of the control unit or of the at least one component of the control unit. Thus it is possible to save costs which arise from cooling measures and an alternative installation location for the control unit within a motor vehicle, etc. In addition, it is possible to conduct the testing of the control unit, in part for temperature change testing, more realistically, so that comparability with field tests exists. The exemplary embodiments and/or exemplary methods of the present invention also makes it possible to determine statistics about how long the temperature of the control unit remained within at least a certain temperature range or temperature delta.

In addition to already known recordings of the duration in the particular temperature range, in one variant of the method the type of the temperature change is also recorded, for example on the basis of temperature differences or temperature deltas of local maximums and minimums for the temperature. Since the temperature changes have an influence on the aging of the component of the control unit, the aging may also be documented during ongoing operation, without the control unit having to be disassembled, opened, and examined by other physical measures for that purpose.

One implementation of the exemplary embodiments and/or exemplary methods of the present invention opens up, for example, the possibility of analyzing thermomechanical damage mechanisms, including among other things the formation of cracks at connecting points, which is caused by differences in the coefficient of thermal expansion of materials employed, for example of the substrate, solder and electronic components. In the event of large and rapid temperature rises, typically a large temperature difference between a starting and ending temperature of a monotonous temperature time pattern at simultaneously high temperature gradients, this leads to mechanical stress and thus to the formation of cracks in the solder, so that a so-called temperature shock results. A temperature rise that is also detectable by the method has an even more damaging effect, the greater the difference between the starting or initial temperature and the ending temperature in a temperature change. A moderate temperature rise, where there is a small temperature change, is normally of minor significance; however, the temperature range in which the temperature rise occurs may be considered. Independent of concrete values of initial and ending temperatures and of temperature differences, the thermal boundary conditions that are important for a state and/or operation of the control unit and for components of the control unit may be detected when the method is implemented, the named temperature rises being detected by counting the temperature data, in this case the temperature deltas that have been passed through.

In the design of the method, counters are set up for temperature differences or so-called temperature deltas, for example 10-15K, 15-20K, 20-25K, which may normally be defined however desired, which collect statistics about the temperature differences or deltas. A temperature delta is defined here by a starting and an ending temperature, which delimit a temperature interval. Depending on the available memory, during the recording a differentiation may be made with regard to various criteria, for example rising and dropping temperature, a temperature range within which the change has occurred, etc. In so doing, various thermal influence factors may be considered.

In one implementation of the method, a search may be made for local maximums and minimums of the temperature on the basis of an algorithm. If a temperature difference between a detected maximum and minimum is greater than a defined threshold, a particular counter for a temperature delta is incremented or increased by one on the basis of the ascertained temperature difference. In the case of a fluctuating rise, where the temperature with rising trend decreases slightly again and again, for example when the vehicle is waiting at a traffic light, it is possible to detect an actual sequence from start to finish. In this case small temperature changes, which are less than 10K, for example, and in the meanwhile occur in the opposite direction, i.e., contrary to the actual trend of the temperature delta, may be ignored. The algorithm may be implemented, for example, by a so-called state machine, also known as a finite-state automaton. The algorithm may also be implemented by some other linkage. The state machine includes two states for detecting a temperature difference or temperature delta. In a first state the unit is switched after a positive temperature increase or temperature rise is stored, and a maximum for the temperature is updated. For the second state, after a negative temperature increase or a temperature drop is stored a minimum for the temperature is updated. But a change is only stored after the temperature has changed by a certain value, for the temperature difference, for example by 10K in the other direction contrary to a trend. The result is that the complete trend, i.e., the rise or drop, is registered in each case. It is also possible here to define different thresholds for the rise and drop.

Moreover, it may be provided to additionally record the cooling of the control unit after it is switched off. This is done, for example, by continuing the recording for a time period that is defined or may be determined as a function of a temperature when switching off and/or a most recently recorded temperature sequence. To this end, a so-called continuous temperature detection operation, in which the method continues to be carried out, may be executed for the control unit. This may be provided in a variant of the method. This is normally not possible, however, since the control unit is also switched off when the vehicle is turned off. Independent of whether the method is also continued after the vehicle is turned off, a temperature may be stored at switch-off and that temperature (switch-off temperature) may be compared to a next temperature (switch-on temperature), which is determined when the vehicle is turned on. The switch-off and/or switch-on temperature may be stored, for example, in an additional memory, which is typically designed as an EEPROM (electrically erasable programmable memory). In addition, a cool-down curve may be calculated by comparing the instantaneous switch-on temperature, which only needs to be stored in a volatile memory, to the switch-off temperature. However, in this process a correct temperature difference is not stored for every switch-off procedure. But when the values for a plurality of switch-off procedures are considered, the average value is usually correct.

The described system is designed to carry out all of the steps of the method presented. At the same time, individual steps of this method may also be carried out by individual components of the system. In addition, functions of the system or functions of individual components of the system may be implemented as steps of the method. In addition, it is possible for steps of the method to be conceived as functions of individual components of the system or of the system as a whole.

The exemplary embodiments and/or exemplary methods of the present invention also relate to a computer program having a program code arrangement for carrying out all of the steps of a described method if the computer program is executed on a computer or in a corresponding arithmetic-logic unit, in particular in a system according to the present invention.

The computer program product according to the present invention having a program code arrangement which are stored on a computer-readable data medium is designed to carry out all of the steps of a described method when the computer program is executed on a computer or a corresponding arithmetic-logic unit, in particular in a system according to the exemplary embodiments and/or exemplary methods of the present invention.

Additional advantages and embodiments of the exemplary embodiments and/or exemplary methods of the present invention are derived from the description and the accompanying drawings.

It goes without saying that the features named above and those still to be explained below are usable not only in the various combinations indicated, but also in other combinations or individually, without going beyond the scope of the exemplary embodiments and/or exemplary methods of the present invention.

### BRIEF DESCRIPTION OF THE DRAWINGS

FIG. 1 shows a schematic representation of a diagram with states and transitions between states which occur in one specific embodiment of the method according to the present invention.

FIG. 2 shows a schematic representation of a diagram with values for temperatures which are determined in one embodiment of the method according to the present invention, as well as with values of counters which are changed during the method.

FIG. 3 shows a schematic representation of one specific embodiment of a control unit according to the present invention.

### DETAILED DESCRIPTION

The exemplary embodiments and/or exemplary methods of the present invention is portrayed schematically in the drawing on the basis of specific embodiments, and will be described in greater detail below with reference to the drawings.

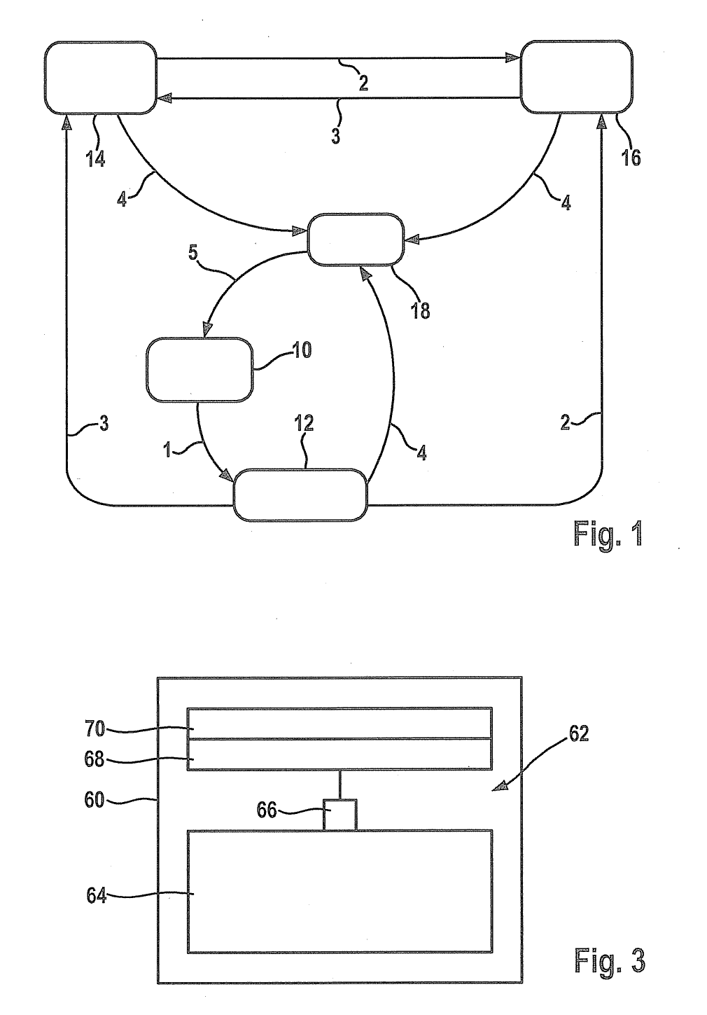

The diagram from FIG. 1 shows five states which are implemented for a control unit during execution of one specific embodiment of the method: initialization of control unit “INIT” 10 as the first state, starting of control unit “START” 12 as the second state, updating of a minimum (Min_Temperature) of temperature (ECU_Temperature) “UPDATEMAXMINSS” 14 as the third state, updating of a maximum (Max_Temperature) of temperature (ECU_Temperature) “UPDATEMAXMINSF” 16 as the fourth state, and switching off of a memory (EEPROM) of control unit “ENDEEPROM” 18 as the fifth state. In the diagram, the numbered arrows between the named states during execution of the method stand for transitions 1, 2, 3, 4, 5 between those states, transitions 1, 2, 3, 4, 5 clarifying connections between the states when there is a change between the states.

Table 1 below includes a description of conditions for transitions 1, 2, 3, 4, 5 between the individual states:

TABLE 1

| Number of the | | |
|---|---|---|
| transition between | | |
| two states | Condition | Description |
| 1 | Valid ECU_Temperature | The initialization cannot be |
| | | carried out until a valid |
| | | determined value for the control |
| | | unit is present for a temperature |
| | | (ECU_Temperature) of the control |
| | | unit. |
| 2 | (ECU_Temperature − | A temperature increase since a |
| | Min Temperature) > | local minimum (Min_Temperature) of |
| | Detection Threshold | the temperature (ECU_Temperature) |
| | | is greater than a threshold |
| | | (Detection_Threshold) for the |
| | | temperature (ECU_Temperature). In |
| | | this case a temperature drop is |
| | | stored and a new minimum |
| | | (Min_Temperature) is initialized |
| | | using the determined temperature |
| | | (ECU_Temperature). |
| 3 | (Max Temperature − | A temperature drop since a local |
| | ECU Temperature) > | maximum (Max_Temperature) is |
| | Detection Threshold | greater than the threshold |
| | | (Detection_Threshold). In this case |
| | | a temperature rise is stored and a |
| | | new maximum (Max_Temperature) is |
| | | initialized using the temperature |
| | | determined for the control unit |
| | | (ECU_Temperature). |
| 4 | After-run | When the control unit is switched |
| | | off, an ignition pulse of the |
| | | vehicle present at terminal 15 (T |
| | | 15) is switched off. Values |
| | | detected for temperature deltas and |
| | | counters are stored in the EEPROM. |
| | | In addition, a temperature delta |
| | | between switching-on and switching- |
| | | off of the control unit is |
| | | determined and stored to provide a |
| | | cooling curve. |
| 5 | T 15 on | Terminal 15 (T 15) is switched on, |
| | | after which a new initialization |
| | | takes place. |

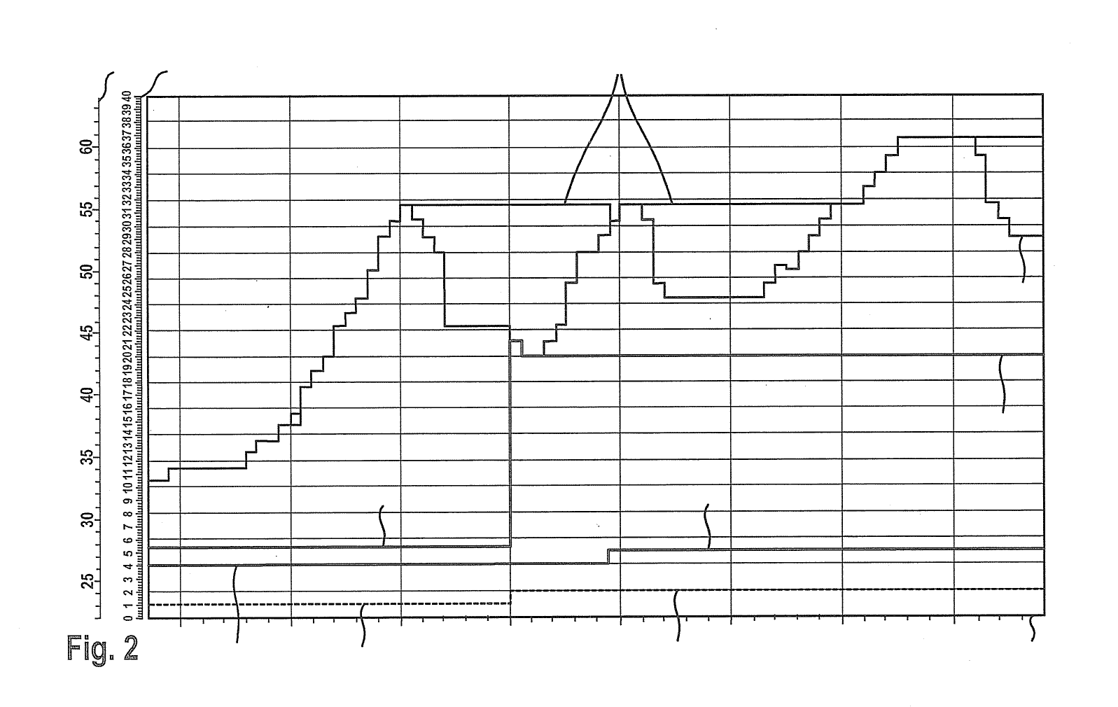

In the diagram from FIG. 2, a first vertically oriented axis 40 for a temperature of a control unit and a second vertically oriented axis 42 for values of a counter are plotted over a horizontally oriented axis 44 for the time. Depicted in the diagram are a first curve 46 for a determined absolute temperature (ECU_Temperature) of the control unit, a second curve 48 for a maximum (Max_Temperature) of the temperature (ECU_Temperature) of the control unit, a third curve 50 for a minimum (Min_Temperature) of the temperature (ECU_Temperature) of the control unit, a fourth curve 52 for the value of a counter for a first temperature delta from 10K to 15K (Delta_Temp_{—}10-15) and a fifth curve 54 for the value of a counter for a second temperature delta from 25K to 30K (Delta_Temp_{—}25-30).

When one embodiment of the method is executed, it is provided that the temperature (ECU_Temperature) initially rises from 33° C. to 55° C. A temperature rise to 55° C. is not stored until point in time t=52 s, since the temperature (ECU_Temperature) dropped in the meantime to 44° C. and thus the threshold of 10K for storing a temperature drop is exceeded. After that the counter for the temperature delta from 25K to 30K (Delta_Temp_{—}25-30) is incremented, since the temperature rise has occurred from a minimum (Min_Temperature) of the temperature (ECU_Temperature), here of 27.6° C., to a maximum (Max_Temperature) of the temperature (ECU_Temperature) of 55.2K by a positive temperature difference of delta_Temp=27.6K. At point in time t=52.9 s a temperature drop to 42.9° C. is stored, since the temperature (ECU_Temperature) rose in the meantime to 53° C. and thus has exceeded the threshold of 10K for storing a temperature rise. In addition, the counter for the temperature delta from 10K to 15K (Delta_Temp_{—}10-15) is incremented, since a temperature drop has occurred, from the maximum (Max_Temperature) of 55.2° C. to the minimum (Min_Temperature) of 43K by a negative temperature difference of 12.2K.

FIG. 3 shows a schematic representation of a design of a control unit 60 which has a specific embodiment of a system 62 for determining an aging of a component of control unit 60 situated in control unit 60, designed as a circuit board 64. System 62 includes a thermometer 66 situated in the area of circuit board 64, a data processing unit 68 with a counter, and a memory 70.

Using this system 62, a specific embodiment of a method for determining a state of at least one component, in this case circuit board 64 of control unit 60, is carried out. Thermometer 66 is used to determine a temperature of the at least one component. For a number of determined temperatures which are determined over a period of time, a type of a temperature change is detected using data processing unit 68 by ascertaining temperature deltas and is recorded in memory 70. Temperature changes that are recorded in that process are used to determine the state of circuit board 64. Each temperature delta here stands for a temperature interval. During operation of the control unit the counter is used to count how often a temperature delta is passed through.

1-13. (canceled)

14. A method for determining a state of at least one component of a control unit, the method comprising:
determining a temperature of the at least one component;
detecting and recording a type of temperature change for a number of temperatures which are determined over a time period; and
using the recorded temperature changes to determine the state of the at least one component of the control unit.

15. The method of claim 14, wherein the at least one component of the control unit is a circuit board.

16. The method of claim 15, wherein the at least one component includes at least one soldering point of the control unit.

17. The method of claim 15, wherein to detect a temperature change from the determined temperature, at least one temperature delta which corresponds to a temperature difference between a local maximum of the temperature and a local minimum of the temperature is determined and recorded.

18. The method of claim 17, wherein for the at least one temperature delta, a counter is set up and used to collect a statistic for the at least one temperature delta.

19. The method of claim 18, wherein the counter for the at least one temperature delta is incremented by one when the temperature difference which corresponds to the at least one temperature delta is exceeded.

20. The method of claim 17, wherein a direction of a temperature change is taken into account, wherein a rising temperature delta is established in the event that the temperature rises, and wherein a falling temperature delta is established in the event that the temperature drops.

21. The method of claim 20, wherein within a temperature delta, a temperature change contrary to the direction of the temperature delta, which is smaller than the temperature delta, is ignored.

22. The method of claim 15, wherein when the control unit is switched off, a temperature of the at least one component is stored, wherein the temperature of the at least one component is determined when the control unit is subsequently switched on, and wherein the temperature determined while switching off is compared with the temperature determined while switching on.

23. A system for determining an aging state of at least one component of a control unit, comprising:
a thermometer to determine a temperature of the at least one component; and
at least one data processing unit to detect and record a type of a temperature change for a number of temperatures, which are determined over a time period, and to use recorded temperature changes to determine the aging state of the at least one component of a control unit.

24. A control unit, comprising:
at least one system for determining an aging state of at least one component of a control unit, including:
a thermometer to determine a temperature of the at least one component; and
at least one data processing unit to detect and record a type of a temperature change for a number of temperatures, which are determined over a time period, and to use recorded temperature changes to determine the aging state of the at least one component of a control unit.

25. A computer readable medium having a computer program which is executable by a processor, comprising:
a program code arrangement having program code for determining a state of at least one component of a control unit by performing the following:
determining a temperature of the at least one component;
detecting and recording a type of temperature change for a number of temperatures which are determined over a time period; and
using the recorded temperature changes to determine the state of the at least one component of the control unit.

26. The computer readable medium of claim 25, wherein the at least one component of the control unit is a circuit board.
